(19) United States
(12) Patent Application Publication
(10) Pub. No.: US 2016/0206152 A1
(43) Pub. Date: Jul. 21, 2016

(54) Egg Press

(71) Applicant: Anthony Allen Garrett, Golden, CO (US)

(72) Inventor: Anthony Allen Garrett, Golden, CO (US)

(73) Assignee: Anthony Allen Garrett, Golden, CO (US)

(21) Appl. No.: 14/593,188

(22) Filed: Jan. 9, 2015

(51) Int. Cl. A47J 43/14

(52) U.S. Cl. CPC A47J 43/14

(57) ABSTRACT

The Egg Press provides a simple, hand operated device for cracking open and filtering the liquid portion of uncooked eggs from their shells. The device separates the liquid from multiple eggs at the same time. The Egg Press utilizes a wire mesh or perforated sheet metal screen basket hanging over a catch bucket and a press plate for crushing the eggs.

Fill the basket with eggs and maneuver the Press Plate over the top of the basket and press in a downward motion to crush the eggs and force the liquid contents of the eggs through the wire mesh or perforated sheet metal screen basket. A catch container captures the liquid portion of the eggs while the eggshells remain in the basket. Utilizing wire mesh or perforated sheet metal with different sized openings accommodates different sized eggs.

### CROSS-REFERENCES TO RELATED APPLICATIONS

Not Applicable

### FEDERALLY-SPONSORED RESEARCH

Not Applicable

### COMPACT DISC APPENDIX

Not Applicable

### U.S. Current Class: 99/498; 99/568

### U.S. Class at Publication: 99/498; 99/568

### Current CPC Class A23N 5/00; A47G 19/28; A47J 43/14

### International Class: A47J 17/00; A23N 5/00

### FIELD OF ENDEAVOR

This invention pertains to Class 99, Foods and Beverages: Apparatus. Subclasses 498 “And removing shell” and 568 “Removing shell.” This invention relates to separating the egg yolk and albumin (white) from the eggshell. This invention further relates to filtering cracked opened, uncooked eggs through a wire mesh or perforated sheet metal screen to separate the combined yolk and albumin from the eggshell. Food Prep, Kitchen Utensil, Restaurant, and Animal Food Prep are related fields.

### BACKGROUND OF THE INVENTION

Egg breaking/separator patents date back to 1893. Many egg separator patents relate only to removing the shells of hardboiled/cooked eggs. The present invention relates only to uncooked eggs. Several existing patents relate to manually bringing the egg into rapid contact with a hard edge to crack open the shell which is then removed by hand. Several existing patents involve separating the egg yolk from the albumin using a spoon or cup-like device while the shell is discarded by hand. None of the patents cited above utilize a wire mesh or perforated metal screen and consequently do not relate to the present invention. The present invention separates the entire liquid contents of the egg from the shell with no differentiation between the yolk and albumin.

Several egg breaking/separator patents are based on hand operated pliers, scissors or clamshell devices. They involve breaking one to three eggs and separating the liquid from the shell. None of them utilizes a wire mesh or perforated sheet metal screen for filtering out the eggshells.

There is a another group of egg separator patents that involve table mounted, motorized conveyor belts that cut one side of the egg and dump the liquid into a container. Some of these patents also offer egg weighing and content inspection features. None of these patents make use of a wire mesh or perforated metal filtering screen.

U.S. Pat. No. 4,961,946 offers a pan like device with holes in the bottom. Eggs are placed in the pan and punctured from below. The holes in the pan allow gravity to help the liquid contents to drop onto a cooking surface below. Wire mesh is not used.

Patent Application Publication US 2011/0042710 A1 uses a centrifugal egg separator that forces broken eggs through a “foraminous cylindrical wall” to filter out the egg shells. This large, complicated device uses centrifugal force to separate the egg contents. It does not use wire mesh or force applied from above.

The present invention uses a flat disc to apply force from above to break open the eggs, forcing their liquid contents through a wire mesh or perforated sheet metal screen. None of the previous patents utilize the process of breaking eggshells with a flat disc and forcing the liquid contents through a wire mesh or perforated sheet metal screen. Hereafter wire mesh or perforated sheet metal screen will be referred to simply as mesh screen.

Prior inventions are complex, inefficient, expensive, or all three. There exists a need for a simple, hand-operated, efficient, and inexpensive egg separator that can rapidly and simultaneously break open and separate the liquid portion of dozens of eggs from their shells using a mesh screen. The present invention, hereafter referred to as the Egg Press, provides a simple, efficient, and inexpensive way to break and separate the liquid portion of uncooked eggs from their shells. The Egg Press uses a hand-held flat disc to crush the eggs and to force their liquid portion through a mesh screen. Hereafter the flat disc will be referred to as the Press Plate.

REFERENCES CITED - U.S. PATENT DOCUMENTS

| Patent number | Year | Inventor |
|---|---|---|
| 490133 | January 1893 | Berrini |
| 499080 | June 1893 | Anderson |
| 562605 | June 1896 | Hedberg |
| 962293 | June 1910 | Anderson |
| 1,409,649 | March 1922 | Becker |
| 3,179,322 | June 1963 | Larson |
| 3,111,150 | November 1963 | Shelton |
| 3,180,381 | April 1965 | Shelton |
| 3,455,356 | July 1969 | Classen |
| 3,480,056 | November 1969 | Willsey |
| 3,532,143 | October 1970 | Williams |
| 3,589,419 | June 1971 | Classen |
| 3,651,846 | March 1972 | Mirara |
| 3,717,088 | February 1973 | Urbonas |
| 3,958,505 | May 1976 | Baker |
| 4,463,666 | August 1984 | Papp |
| 4,534,284 | August 1985 | Fujimura et al. |
| 4,542,584 | September 1985 | Talbot |
| 4,554,866 | November 1985 | Hampton |
| 4,665,813 | May 1987 | Maisonneuve |
| 4,787,306 | November 1988 | Johnson |
| 4,961,946 | October 1990 | Shimizu |
| 5,069,119 | December 1991 | Idowu |
| 5,083,508 | January 1992 | Banks et al. |
| 5,197,380 | March 1993 | Fisher |
| 5,293,815 | March 1994 | Tomosue |
| 5,325,768 | July 1994 | van den Hazel |
| 5,390,591 | February 1995 | Fast |
| 5,438,919 | August 1995 | Idowu |
| 5,460,083 | October 1995 | Hutchinson et al. |
| 5,483,872 | January 1996 | Nield |
| 5,617,782 | April 1997 | Thomas |
| 5,628,246 | May 1997 | Kristensen |
| 5,634,397 | June 1997 | Hutchinson et al. |
| 5,784,953 | July 1998 | Wang |
| 6,135,017 | October 2000 | Wang et al |
| US2007/01011871A1 | May 2001 | Patterson |
| 6,279,232B2 | August 2001 | Cho |
| 6,649,203 | November 2003 | Thoroski |
| 6,675,701B2 | January 2004 | Christiansen |
| 7,363,853B2 | April 2008 | Dolub |
| 7,836,823 | November 2010 | Vassallo |
| US2001/00411710A1 | February 2011 | Collins |
| 8,069,779B2 | December 2011 | Dolub |
| US201/0125210A1 | May 2012 | Myoung |

### BRIEF SUMMARY OF THE INVENTION

The Egg Press invention provides a hand-operated device for simultaneously breaking open and filtering the liquid portion, yolk and albumin, of multiple uncooked, eggs from their shells using a wire mesh screen basket. The Egg Press utilizes a mesh screen basket to contain the eggs, which are then pressed against the basket walls and bottom with a hand-held Press Plate. The eggshells remain in the basket while the liquid portion of the egg passes through the wire mesh walls and is captured in a container located below the basket.

### BRIEF DESCRIPTION OF THE SEVERAL VIEWS OF THE DRAWINGS

Drawing 1/4 shows an orthographic view of the entire Egg Press device.

FIG. 1 shows the basket with structure rods and wire mesh. Dual purpose lifting handles/hanging brackets are welded to the upper hoop. The hanging brackets allow the basket to hang from the top rim of a bucket during operation.

FIG. 2 shows the Press Plate. Hand grip handles are welded to the Press Plate to assist in pressing down on the eggs contained in the basket.

Drawing 2/4 shows an elevation view of the Egg Press device.

FIG. 3 shows the basket with structure rods and wire mesh containing uncooked eggs. Lifting handles/hanging brackets are welded to the upper hoop of the basket. The hanging brackets allow the basket to hang from the top rim of a bucket during operation.

FIG. 4 shows the Press Plate above the basket opening. Hand grip handles are welded to the Press Plate.

Drawing 3/4,

FIG. 5 provides a plan view of the Egg Press. Two bottom, horizontal support rods are welded to the bottom hoop. The top and bottom structural hoops are welded to four equally spaced, vertical support rods. Two dual purpose lifting handles/hanging brackets are welded to the top hoop. Wire mesh is welded to the top and bottom hoops and the four vertical support rods.

Drawing 4/4,

FIG. 6 shows the plan view of the Press Plate. The Press Plate is a flat disk of sufficient strength to break the eggs. The Press Plate is smaller in diameter than the upper and lower support hoops such that it easily fits inside the basket. Hand grip handles are welded to the upper side of the Press Plate.

FIG. 7 shows the elevation view of the press plate.

Photograph 1/1,

FIG. 8 shows the overview and operation of the Egg Press. The operator grasps the Press Plate with both hands and presses down, forcing the eggs to break and the liquid portion to be squeezed through the wire mesh.

### DETAILED DESCRIPTION OF THE INVENTION

The Egg Press provides a simple and inexpensive hand operated device for cracking open and separating the liquid portion, of multiple uncooked eggs from their shells. Large numbers of eggs can be opened and separated at one time. The device is suitable for any size egg. The device can be fabricated from most metals and plastics. Typically stainless steel, carbon steel or aluminum would be the materials of choice.

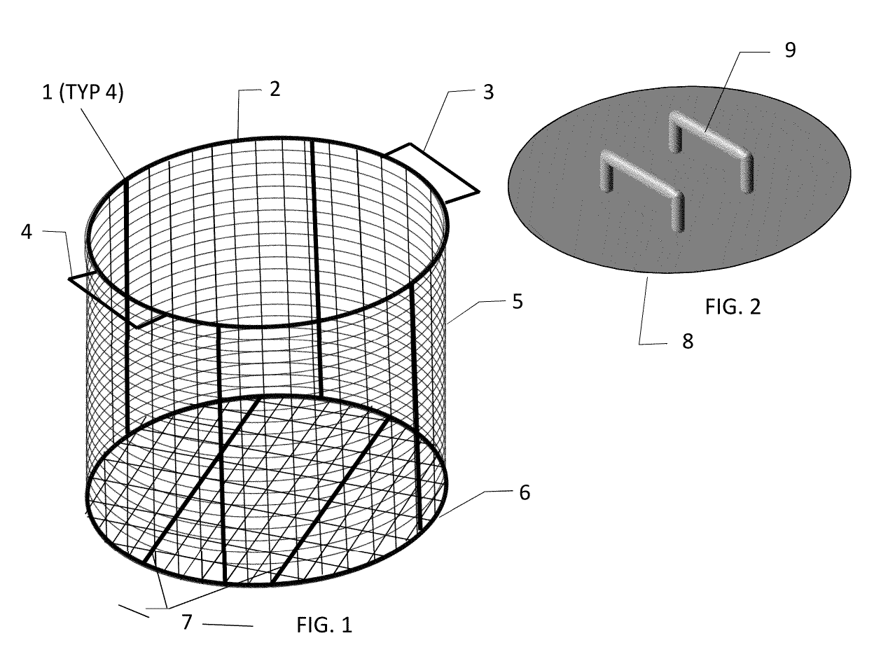

The device is constructed utilizing wire mesh or perforated sheet metal and rods welded together to form a basket with an open top (see Drawing 1, FIG. 1) and a flat Press Plate with handles (see Drawing 1, FIG. 2.) Eggs are placed inside the basket and the Press Plate is placed on top of the eggs. The operator grips the press plate from above and presses it into the basket thereby crushing the eggs and forcing the liquid out through the walls and bottom of the basket. The downward force cracks the eggs and the wire mesh screen filters the broken eggshells from the liquid portion of the eggs. A container located under the basket collects the liquid portion of the eggs. The eggshells remain in the basket. The eggshells are dumped out prior to separating the next batch of eggs.

The Egg Press is constructed by welding rods together as shown in Drawings 1, 2, and 3, to form the support structure for the basket. The basket size and mesh opening spacing are sized to handle the desired number and size of eggs to be separated. A basket capable of separating 8 dozen eggs should be approximately 10 inches in diameter and 8 inches deep. The structural rods would be approximately 3/16 inches in diameter.

Drawing 1/4—FIG. 1 shows an orthographic overview of the Egg Press. FIG. 2 shows an orthographic view of Press Plate. Four vertical rods (1) are welded to the top and bottom support hoops (2,6). Support handle/brackets (3,4) are welded to each side of the top hoop (2). Wire mesh (5) is attached to the sidewalls and bottom of the basket. Two hand-holds (9) are welded to the Press Plate (8).

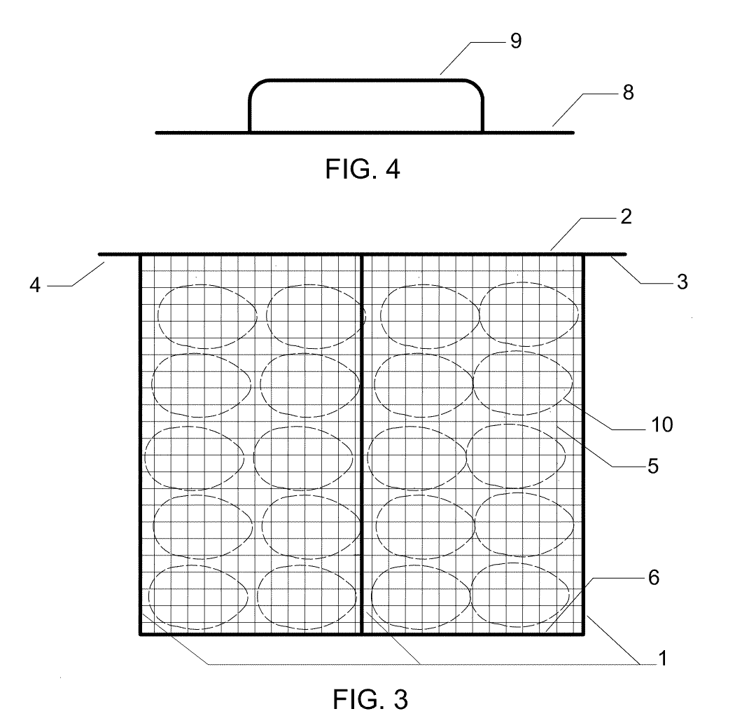

Drawing 2/4—FIG. 3 shows an elevation overview of the Egg Press with eggs inside the basket. FIG. 4 shows an elevation view of the Press Plate. Four vertical rods (1) are welded to the top and bottom support hoops (2,6). Lifting handle/hanging brackets (3,4) are welded to each side of the top hoop (2). Wire mesh (5) is attached to the sidewalls and bottom of the basket. Two hand-holds (9) are welded to the Press Plate (8). Eggs are shown inside the basket (10).

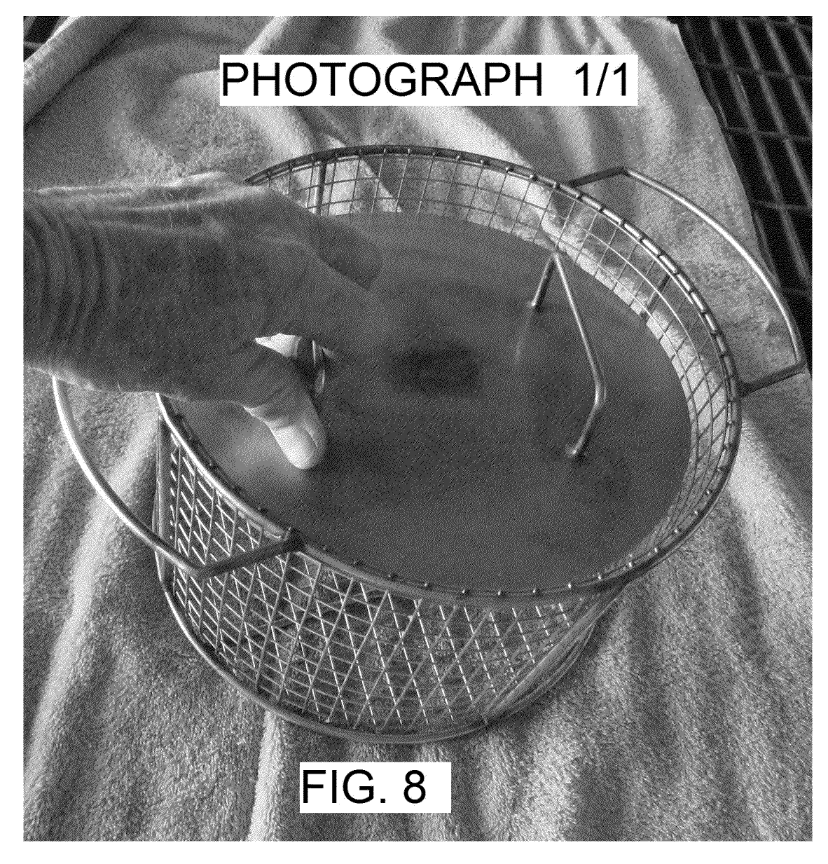

The basket can be fabricated by attaching the wire mesh (5) inside the basket structure on the bottom and around the sides. Weld the individual mesh wires to the top hoop of the basket structure. See Photograph 1-1, FIG. 8. Weld the bottom wires to the side wires. For typical large chicken eggs, the wire mesh screen should use approximately size 16 AWG wire. The wire mesh/perforated screen hole opening size should be about ½ inch. Wire size and openings can be adjusted to meet individual requirements.

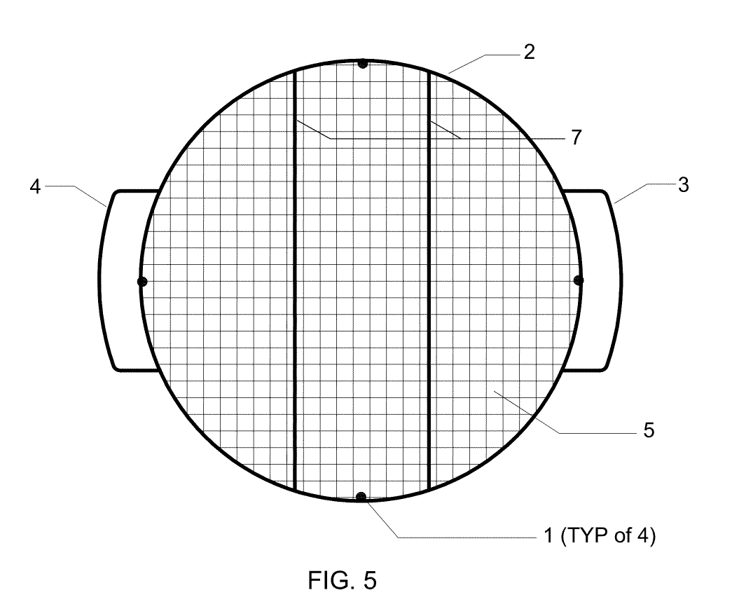

Drawing 3/4—FIG. 5 provides a plan view of the Egg Press. Two bottom, horizontal support rods (7) are welded to the bottom hoop (6). The top and bottom structural hoops (2,6) are welded to four equally spaced, vertical support rods (1). Two dual purpose lifting handle/hanging brackets (3,4) are welded to the top hoop (2). The hanging brackets provide a means to hang the basket over the top rim of a five gallon bucket. The wire mesh screen (5) is welded to the bottom hoop (6), the vertical rods (1) and the top hoop (2).

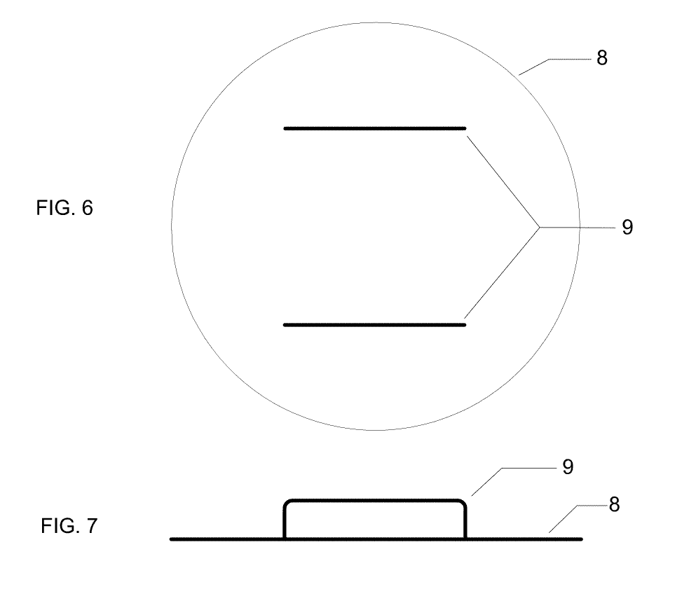

Drawing 4/4—FIG. 6 shows the plan view and FIG. 7 shows elevation view of the Press Plate device. The Press Plate (8) is a circular disk of sufficient strength to break the eggs. It is smaller in diameter than the upper and lower support hoops such that it easily fits inside the basket. Grip handles (9) are welded to the upper side of the Press Plate (8).

The Press Plate is constructed by fabricating a sheet metal circular disc about ½ inch smaller in diameter than the inside diameter of the basket. Weld grip handles on the top of the disc.

1. A hand-operated tool for manually cracking and breaking open dozens of uncooked eggs to filter the liquid portion of the eggs from their shells using a wire mesh or perforated sheet metal screen basket and a flat disk called a Press Plate. Using manual force on the Press Plate to crack the shells, which are caught in the wire mesh screen, the liquid egg portion passes through the wire mesh bottom and siding of the basket.

2. An open-top wire mesh basket for separating the liquid portion of eggs from their shells, independent of egg shape, size and shell thickness, with upper handles and mesh siding; comprised of robust top and bottom hoops and smaller mesh on the siding and basket bottom.

3. The open-top wire mesh basket for loading the eggs; basket has brackets mounted on its top hoop to provide the means to suspend the basket above a bucket to catch the liquid portion of the eggs as they pass through the wire mesh on the basket bottom and sides.

4. A circular metal Press Plate for placing in the top of the basket above the eggs; used to manually press down on the eggs such that they crack open and the liquid portion of the eggs is forced out through the sides and bottom of the wire mesh basket while the shells remain in the wire mesh basket.

5. An open top to the wire mesh basket, allowing for the remaining eggshells in the basket, after the Press Plate has crushed the eggs, to be tipped out and discarded.
